(19) United States
(12) Patent Application Publication
(10) Pub. No.: US 2009/0079545 A1
(43) Pub. Date: Mar. 26, 2009

(54) FLEXIBLE RFID TAG DEVICE AND METHOD FOR CONSTRUCTING SAME

(76) Inventors: Luke Chow, Bethesda, MD (US); Yongbo Chen, Germantown, MD (US)

Correspondence Address: BIRCH STEWART KOLASCH & BIRCH, PO BOX 747, FALLS CHURCH, VA, 22040-0747, US

(21) Appl. No.: 12/237,929

(22) Filed: Sep. 25, 2008

Related U.S. Application Data
(60) Provisional application No. 60/975,256, filed on Sep. 26, 2007.

(51) Int. Cl. H04Q 5/22

(52) U.S. Cl. 340/10.1

(57) ABSTRACT

The present invention relates generally to a flexible RFID tag comprising an RFID inlay and added protection via one or more means of encapsulation, and method of constructing a flexible RFID tag.

This application claims priority to provisional application Ser. No. 60/975,256, filed Sep. 26, 2007. The entire disclosure of said application Ser. No. 60/975,256 is expressly incorporated herein by reference.

### FIELD OF THE INVENTION

The present invention relates generally to methods for constructing radio frequency identification (“RFID”) tags, and more specifically, to methods for constructing malleable, pliable, flexible RFID tags.

### DESCRIPTION OF RELATED ART

An RFID tag is comprised of an RFID inlay encased within a device. An RFID inlay is comprised of an RFID chip and antenna array encased in a thin strip of flexible polymeric film. The polymeric coating of these inlays offers virtually no protection for the chip and antenna array. An inlay cannot be used in an RFID application without being enclosed within another device or substance that will provide additional protection. Inlays are currently enclosed in a variety of devices including hard plastics and soft polymeric devices.

However, the inlays encased in soft polymeric devices tend to fail after a relatively short period of time. Thus, RFID applications that require a flexible RFID tag currently have a higher rate of failures and require frequent RFID tag replacement driving up the cost of use of the RFID application due to maintenance and materials costs.

As such, there is a need for a method of encasing RFID inlays within a malleable, pliable, flexible device or substance that offers sufficient protective qualities to maintain the usual life-cycle of the chip and antenna array for RFID applications requiring flexible RFID tags.

### SUMMARY OF THE INVENTION

This invention provides a flexible RFID tag. The flexible RFID tag of the present invention includes an RFID inlay laminated to create an air pocket or cavity around the inlay chip and the inlay chip and antenna interface. In accordance with the present invention, this laminated inlay is encapsulated within a flexible substance, preferably, a flexible substance that is designed to withstand extreme heat or extreme cold or both. Typically, in the present invention, the laminated inlay is encapsulated within a cavity within a flexible substance. This cavity may be filled, either completely or to less than full capacity, with a liquid or gel like substance. The air pocket or cavity may be hermetically sealed or may be otherwise air tight.

In another embodiment, this invention provides a method for constructing a flexible RFID tag. The method of the present invention includes providing an RFID inlay, subjecting it to a lamination process, including creating an air cavity surrounding the inlay chip and the chip and antenna interface encapsulating the laminated inlay within a flexible substance. The method of this invention may include introducing a gel substance to fill the air cavity. The lamination process used in the present invention may be a cold lamination process or a hot lamination process or a hot chemical lamination process.

### BRIEF DESCRIPTION OF THE DRAWINGS

The accompanying drawings, which are incorporated in and constitute a part of this specification, illustrate embodiments of the invention and, together with the description, explain the principles of the invention. In the drawings:

FIG. 1 is an exemplary illustration of an RFID inlay;

FIGS. 2A and 2B provide exemplary illustrations of a laminated off-the-shelf RFID inlay with an air pocket around the chip and chip and antenna array interface;

FIGS. 3A and 3B provide exemplary illustrations of an RFID tag comprised on an RFID inlay, laminated with an air pocket around the chip and chip and antenna array interface, and further encased in an additional flexible substance.

FIGS. 4A and 4B provide exemplary illustrations of first layer lamination strips;

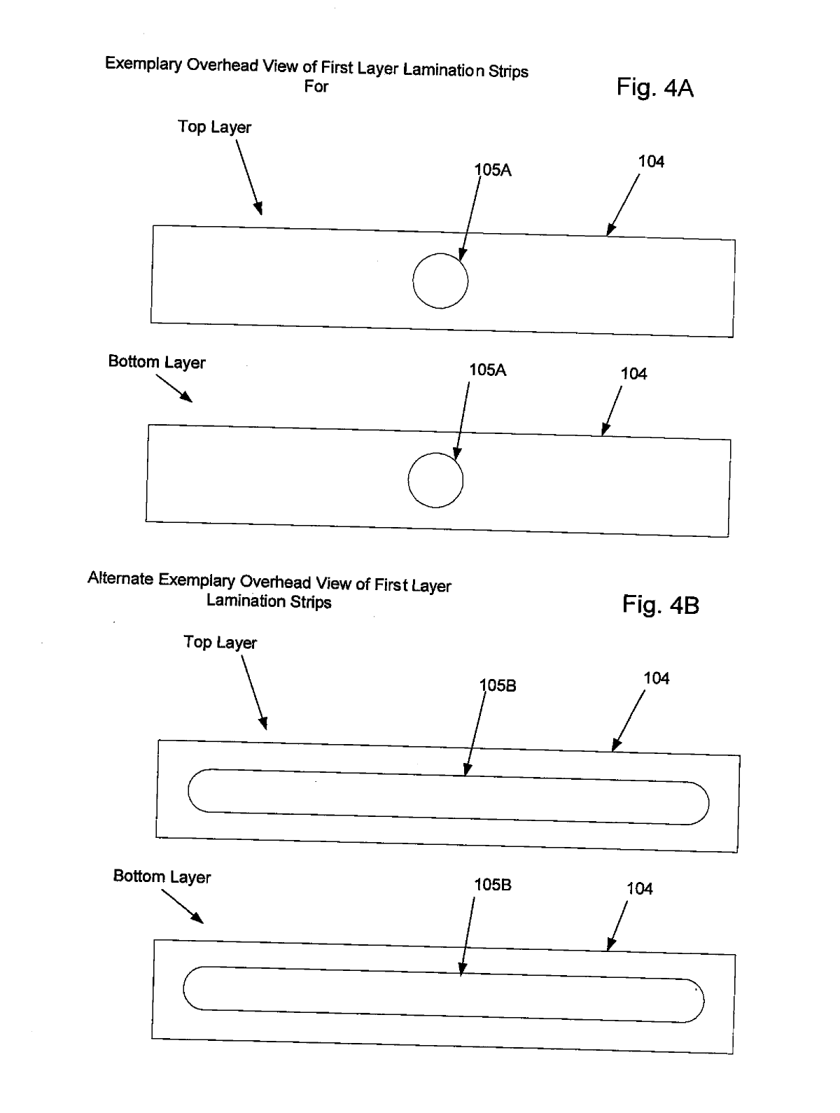

FIG. 5 is a schematic illustration a flexible RFID tag layering process.

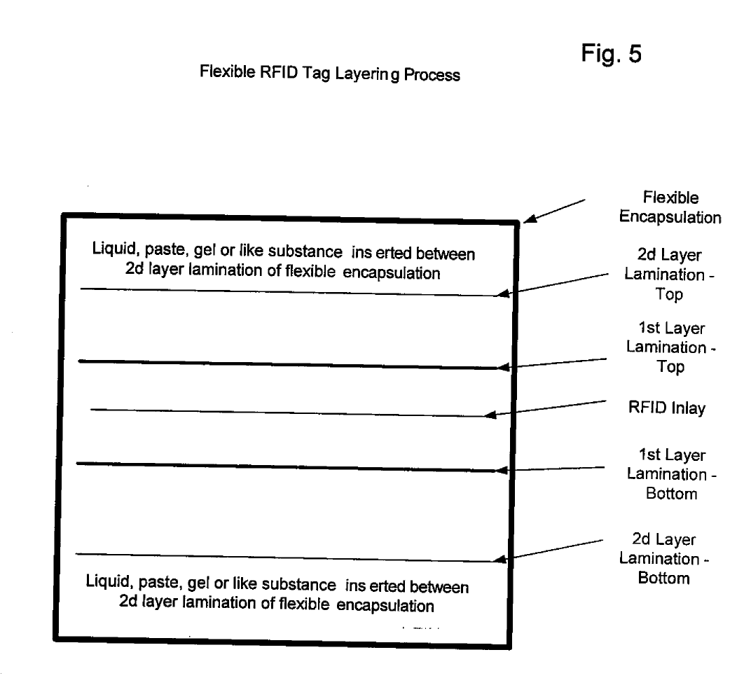

### DETAILED DESCRIPTION

Reference will now be made in detail to the features and principles of the present invention, examples of which are illustrated in the accompanying drawings. Wherever possible, the same reference numbers will be used throughout the drawings to refer to the same or like parts.

The present invention relates generally to devices/substances and methods for constructing reliable and flexible RFID tags. For example, some flexible RFID tags are constructed using an inlay encased within a soft encasement that when subjected to loads or certain applications, the tag bends easily and exert stresses on the inlay, causing premature failure. Other flexible RFID tags are constructed with such extremely high pressure during the process of fabrication that the inlay is subject to significant stress both during the fabrication process and while encapsulated in the resulting RFID tag, again resulting in frequent failure events.

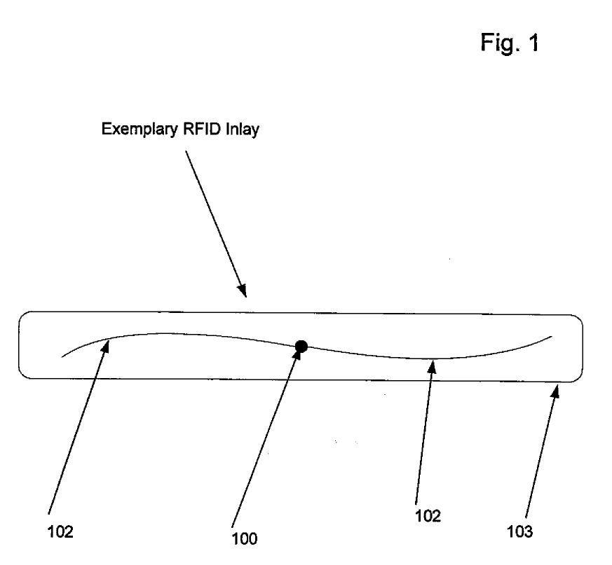

FIG. 1 is an exemplary overhead illustration of an RFID inlay. The components of a typical inlay may include a patch, an RFID chip 100, a means for fastening an antenna array, an antenna array 102, and a polymeric substance 103 used to enclose all such components. RFID inlays are very small, and the components are very fragile, as are chip and antenna interface. RFID tag failures tend to occur as a result of damage to one or more of the components including damage to the chip or the chip and antenna interface area which thereby weakens or terminates the RFID signal.

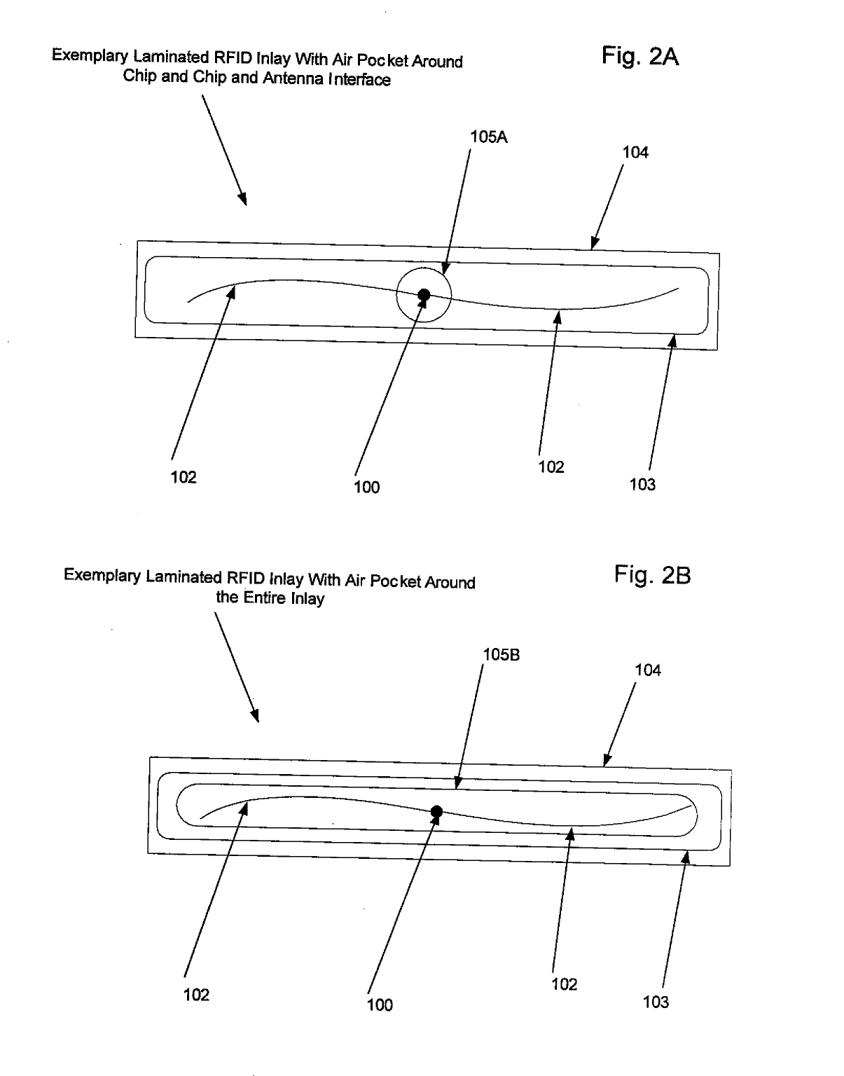

FIG. 2A is an exemplary overhead illustration of an inlay after being laminated 104 in such a manner as to create an air pocket 105A around the chip and chip and antenna interface. The air pocket 105A circles the chip and chip and antenna interface within the laminate. FIG. 2B is an exemplary overhead illustration of an inlay after being laminated 104 in such a manner as to create an air pocket 105B around the entire inlay. The lamination may be accomplished using a lamination process that involves some heat and pressure to achieve the desired quality. Other lamination processes that may be used involve photochemicals, chemicals, adhesives, gels, castings, elastomers, ultrasonics, vibration, lasers and light.

The object is to create a pocket of air within the laminate around the chip and the chip and antenna interface or, in the alternative, the entire inlay. The air pocket creates an air cavity and the laminate material around the air pocket adds localized rigidity around the chip and chip and antenna interface area and thus protection to the chip and the chip and antenna interface, while allowing the extended antenna array to remain flexible. In the alternative, the air pocket adds protection for the entire inlay. This will protect the chip and chip and antenna interface or, in the alternative, the entire inlay, from direct contact with the laminate and the laminate further protects the same from direct contact with the additional encasing substance. The air pocket also protects the chip and chip and antenna interface area from a sharp bend that could introduce sever stress on the chip and antenna interface and tend to weaken or break the chip and antenna connection. In the alternative, the entire inlay is protected in the same manner.

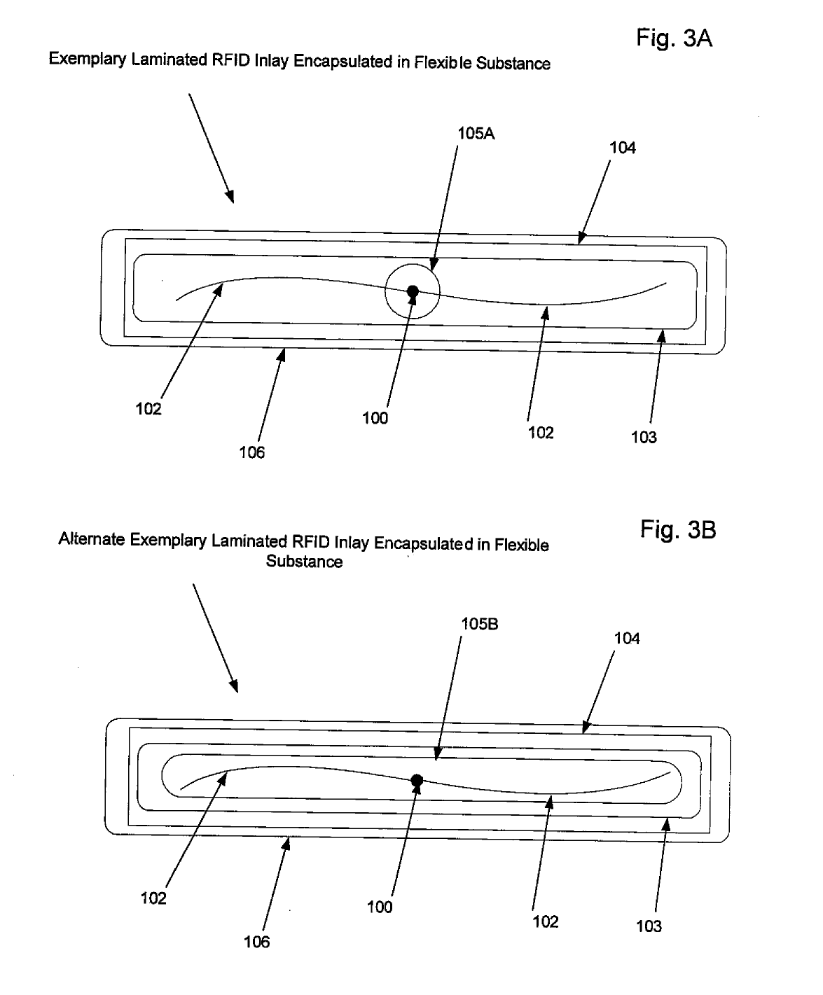

FIG. 3A is an exemplary overhead, cut-away illustration of an RFID tag comprised of an inlay after lamination and encapsulation within an additional flexible substance 106. FIG. 3B is an exemplary overhead, cut-away illustration of the alternative air pocket created for the entire inlay.

Another means of protecting the chip and chip and antenna interface area or the entire inlay is to fill the air pocket 105A or 105B with a liquid, paste, gel or gel-like substance within the laminate directly around the chip and chip and antenna interface area or the entire inlay. The gel substance would further reinforce the pocket and maintain desired space between the laminate and the chip and chip and antenna interface area or the entire inlay. It would also add protection and support the laminate against a sharp bend to the chip and antenna interface area or the entire inlay.

Another means of protecting the entire inlay, including the chip, the chip and antenna interface area, and the remaining antenna array is to encapsulate the inlay in an air pocket or cavity inside a sturdier yet flexible substance 106 such as rubber or plastic or similar material.

Another means of protecting the entire inlay, including the chip, the chip and antenna interface area, and the remaining antenna array is to laminate the inlay in such a manner as to create an air pocket 105A or 105B between the laminate layers around the chip and chip and antenna interface or entire inlay and to encapsulate the laminated inlay in an air pocket or cavity within a flexible substance 106 such as rubber or plastic or similar material.

Another means of protecting the entire inlay, including the chip, the chip and antenna interface area, and the remaining antenna array is to encapsulate the inlay in a cavity inside a sturdier yet flexible substance 106 such as rubber or plastic or similar material, and then fill the cavity with a liquid or gel substance. The liquid or gel substance will offer support and protection for the entire inlay by lubricating and cushioning contact between the inlay and its components and the inner cavity walls, and yet maintain the flexibility of the encapsulating substance.

Another means of protecting the entire inlay, including the chip, the chip and antenna interface area, and the remaining antenna array is to encapsulate the inlay in a cavity inside a sturdier yet flexible substance 106 such as rubber or plastic or similar material, and then filling the cavity to less than one hundred percent capacity with a liquid, paste or gel substance. The liquid, paste or gel substance will offer support and protection for the entire inlay by lubricating and cushioning contact between the inlay and its components and the inner cavity walls, and yet maintain the flexibility of the encapsulating substance. By filling the cavity with a liquid, paste or gel like substance less than one hundred percent capacity will maintain most of the aforementioned protective qualities yet allow additional RFID tag flexibility.

Another means of protecting the entire inlay is that described in paragraph 0019 above but after the inlay has been laminated to create an air pocket 105A or 105B around the chip and chip and antenna interface or entire inlay.

Another application of the foregoing is to use an encapsulating substance that is designed to withstand extreme temperatures both hot and cold.

Another application of the foregoing is to use an encapsulating substance and method that is designed to be both air tight and water tight.

The preferred materials to construct a flexible RFID tag include silicone, polyurethane, polyesters, thermal plastic rubbers and other similar flexible materials.

A low-pressure encapsulation process will also help to avoid damaging the RFID inlay chip and chip and antenna interface.

The encapsulation of the inlay can be achieved through several methods. One of them is by injecting the encapsulant into a mold at a pressure sufficient to inject the material without damaging the inlay components. Other methods include processing the encapsulant in gel or paste forms. Still other processes include injection molding, extrusion, blow molding and casting of the flexible to semi flexible encapsulant material.

Modifications and adaptations of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A flexible RFID tag, comprising:
an RFID inlay
laminated to create an air pocket or cavity around the inlay chip and the inlay chip and antenna interface or around the entire inlay.

2. A flexible RFID tag, comprising:
an RFID inlay
laminated to create an air pocket or cavity around the inlay chip and the inlay chip and antenna interface or the entire inlay;
said laminated inlay encapsulated within a flexible substance.

3. The flexible RFID tag of claim 2, wherein
said laminated inlay is encapsulated within an air pocket or cavity within a flexible substance.

4. The flexible RFID tag of claim 3, wherein
said cavity is filled with a liquid or gel like substance.

5. The flexible RFID tag of claim 4, wherein
said cavity is filled less than full capacity with a liquid or gel like substance.

6. The flexible RFID tag of claim 1, wherein the air pocket or cavity is air tight.

7. The flexible RFID tag of claim 6, wherein the air pocket or cavity is hermetically sealed.

8. The flexible RFID tag of claim 1, wherein the flexible substance is designed to withstand extreme heat or extreme cold or both.

9. A flexible RFID tag, comprising:
an RFID inlay,
said inlay encapsulated within an air pocket or cavity within a flexible substance.

10. The flexible RFID tag of claim 9, comprising:
an RFID inlay,
said inlay encapsulated within a cavity within a flexible substance,
said cavity filled with a liquid or gel like substance.

11. The flexible RFID tag of claim 10, comprising:
an RFID inlay,
said inlay encapsulated within a cavity within a flexible substance,
said cavity filled less than full capacity with a liquid or gel like substance.

12. The flexible RFID tag of claim 9, wherein the air pocket or cavity is air tight.

13. The flexible RFID tag of claim 12, wherein the air pocket or cavity is hermetically sealed.

14. The flexible RFID tag of claim 9, wherein the flexible substance is designed to withstand extreme heat or extreme cold or both.

15. A method for constructing a flexible RFID tag, comprising:
providing an RFID inlay;
conducting a lamination process;
creating an air cavity surrounding the inlay chip and the chip and antenna interface or entire inlay; and
encapsulating the laminated inlay within a flexible substance.

16. The method of claim 15, further including:
introducing a gel substance to fill the air cavity.

17. The method of claim 15, using a cold lamination process.

18. The method of claim 15, using a hot lamination process.

19. The method of claim 15, using a hot chemical lamination process.
